(19) United States
(12) Patent Application Publication
(10) Pub. No.: US 2025/0025900 A1
(43) Pub. Date: Jan. 23, 2025

(54) HIGH VOLUME DISPENSING PUMP WITH SHORTENED AXIAL TRAVEL

(71) Applicant: RIEKE PACKAGING SYSTEMS LIMITED, Leicestershire (GB)

(72) Inventors: Simon Christopher KNIGHT, Bridgend South Wales (GB); Gaurang MITTAL, Noida (IN); Prantik CHANDA, Noida (IN)

(21) Appl. No.: 18/714,752

(22) PCT Filed: Dec. 5, 2022
(86) PCT No.: PCT/EP2022/084464

§ 371 Date: May 30, 2024

Related U.S. Application Data
(60) Provisional application No. 63/285,746, filed on Dec. 3, 2021.

(30) Foreign Application Priority Data
Oct. 21, 2022 (IN) 202241059678

(51) Int. Cl. B05B 11/10; A47J 47/01

(52) U.S. Cl. CPC B05B 11/1001; A47J 47/01; B05B 11/1047; B05B 11/105; B05B 11/1077

(57) ABSTRACT

A food and beverage reciprocating dispenser relies upon an external engine to shorten the axial travel and spring force required for actuation. This enables the delivery of more accurate and consistent dose volumes. The resulting pump has “bore ratios” that are improved by an order of magnitude in comparison to conventional designs.

### TECHNICAL FIELD

This application claims priority to United States' provisional patent application Ser. No. 63/285,746 filed on Dec. 3, 2021 and Indian patent application No. 202241059678 filed on Oct. 19, 2022.

The present invention relates generally to pump dispensers and, more specifically, to an improved pump and dispenser arrangement incorporating an expanded diameter pump chamber seated above the closure cap, external to the container to which it is affixed. The pump delivers a large dispensed dose volume while shortening the axial travel, resulting in novel and increased dispensed volume to axial travel ratios and bore ratios, both of which improve the consistency of dispensing operations and reduce the effort/force required for actuation.

### BACKGROUND

United States Patent Publications 2011/0174840; 2013/0098943; and 2019/0223655, as well as international publication WO 2020/144369, all disclose various dispensing systems specifically designed for and used in food dispensing operations and, more specifically, the provision of standardized volumes of syrups and other fluid flavorings and ingredients onto or into food and beverage preparations. These disclosures are all incorporated by reference herein.

Food and beverage operations entail the need to repeatedly apply an identical amount of fluid. In comparison to other dispensing operations relying on reciprocating pumps, food and beverage applications require comparatively larger doses (in excess of 5 mL, with 10, 20, 30, and 50 mL doses being common/preferred. Food and beverage pumps must also be robust and easy to actuate, given the fast-paced restaurant and service applications in which they are used.

Current food and beverage reciprocating pumps require an axial travel (i.e., the displacement distance of the plunger head through a complete and full dosing cycle) in excess of 5 mm. If the plunger head does not complete this travel length, insufficient suction is applied and a less than desired volume of fluid will be dispensed. The issue is particularly difficult when the dispensed fluid is a flavoring syrup, insofar as smaller dispensed doses negatively impact the flavor of the food/beverage being served.

One common style of conventional pump is shown in FIGS. 1A through 1C. A biasing member is provided around a plunger/stem, which is connected to a piston within the pump chamber. The movement of the piston varies the volume of the pump chamber so as to draw and expel fluid from it, depending upon the motion of travel. The pump chamber is disposed within and below the container neck, thereby reducing the total height of the combined/attached dispenser and container.

Another type of dispensing solution involves measured dose dispensers, such as those found in United States Patent Publications 2011/0198371; 2015/0078801; and 2018/0299310A1 (all also incorporated by reference). While these designs deliver more precise and repeatable doses, they tend to require inversion and/or squeezing to fill the dosing chamber. Some arrangements also rely upon flow channels disposed coaxially outside of the chamber, thereby requiring large diameter container necks to receive the pump engine. Given these and other shortcomings, the use of conventional measure dosing devices is not practical for food and beverage applications. In fact, the exigencies of food and beverage dispensing may render many other dispensers (foamers, mist sprayers, etc.) impractical, given the viscosity of fluids dispensed in food and beverage applications and the need for repeatable, reliable, cost effective, and comparatively easy to operate pumps.

A dispenser that is appropriate for repeatedly providing consistent, standardized volumes/doses with decreased axial travel would be welcome. A particularly desirable trait would be a large volume (i.e., ≥5 mL and, more preferably, ≥10 mL doses) pump with a shortened axial travel (i.e., less than one half the conventional counterparts and/or ≤2.0 cm of distance/downward depression) and a biasing member having reduced actuation force, as this combination of traits would simplify dispensing for food and beverage service applications.

### SUMMARY

A food and beverage pump is specifically designed to deliver syrups and other viscous or water-like fluids commonly used in the food and beverage industry. The pump has a reciprocating head and plunger, but with significantly reduced axial travel. This shorter travel distance enables the use of metal or plastic springs, while dispensing consistent and reliable high volume doses (i.e., equal to or greater than 5 mL and up to 25 mL or more).

The inventive pump relies upon an external engine in which the pump chamber is positioned above and/or integrated with the top of the closure cap. By eliminating the conventional coaxial pump chamber-in-container-neck design, the pump chamber, as well as its inlet and outlet bores can all have a significantly increased diameter. The chamber is sealed by a snap-fit style cap or collar. Tethered flap valves seal the chamber, while a reciprocating piston stem selectively seals vent apertures provided in a sleeve that rests within and defines the volume of the pump chamber allows for proper return air.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIGS. 1A through 1C depict a conventional, prior art reciprocating dispenser pump, having an elongated, narrow pump chamber (positioned beneath the closure cap) and longer axial travel in comparison to the inventive pump shown in FIG. 2A. FIG. 1A is a perspective side view, while FIGS. 1B and 1C are isolated, cross-sectional perspective views illustrating diameter and cross sectional area (i.e., the bore) adjacent the outlet (FIG. 1B) and the inlet (FIG. 1C, with the valve omitted).

FIG. 2A is a perspective side view of one aspect of the invention, while FIGS. 2B through 2D are isolated, cross-sectional perspective views, comparable to FIGS. 1B and 1C, illustrating the diameter and cross sectional area (i.e., the bore) adjacent the outlet (D1, FIG. 2B) and the inlet (D2, FIG. 2C), as well as the diameter within the expanded pump chamber (D3, FIG. 2D). Each of these diameters is defined by the arrows found in FIGS. 2B through 2D.

FIGS. 3A and 3B are, respectively speaking, complimentary top and bottom perspective views of the pump of FIG. 2A, while FIGS. 4A and 4B are corresponding and complimentary views of all the individual components thereof, shown in isolation. FIG. 4C is a side plan view of the isolated, individual components shown in FIGS. 4A and 4B.

FIG. 5A is a cross-sectional side plan view of the pump of FIG. 2A, while FIGS. 5B and 5C are, respectively speaking, complimentary cross sectional, perspective views of the actuator head incorporating an alternative nozzle tip in contrast to the tip illustrated in FIG. 5A.

FIGS. 6A and 6B are, respectively speaking, complimentary top and bottom perspective views of an alternative, all-plastic biasing member in contrast to the spring illustrated in FIGS. 4A through 5A, while FIG. 6C is a cross sectional side plan view thereof.

FIG. 7A is a perspective view of the inventive closure element and push stem of the pump shown in FIG. 2A, while FIG. 7B is a corresponding and complimentary view of all the individual components thereof, shown in isolation. FIG. 7C is a cross sectional perspective view of the closure element and push stem shown in FIG. 7A, with FIG. 7D being a cross sectional perspective view and FIG. 7E being a cross sectional side plan view of the individual components shown from FIG. 7B.

FIG. 8A is a perspective view of an alternative push stem in contrast to the stem shown in FIGS. 7A through 7E while FIG. 8B is a cross sectional perspective view and FIG. 8C is a cross sectional side plan view thereof.

FIGS. 9A through 9C are cross sectional side plan views, with FIG. 9A illustrating a commonly experienced problem of “blowby” when the pump of FIG. 2A is not actuated along its intended axis of actuation (i.e., vertical) and FIG. 9B showing an alternative flexible spherical wiper and hinge joint extension that can be provided on the lower end of the push stem.

FIG. 9D is a cross sectional schematic view of the flexible spherical wiper as it might be adapted to the piston stem shown in FIG. 8C.

FIG. 10 is an cross sectional side plan view of isolating the closure element, push stem, and portions of the head as shown in FIG. 5A (but with the biasing member/spring omitted) to highlight the fluid pathways, venting/air pathways, and sealing surfaces.

FIGS. 11A and 11B are comparative, cross sectional perspective views of the closure element and push stem (but omitting the valves) with a metallic spring (FIG. 11A) and the alternative, all-plastic biasing member of FIGS. 6A through 6C and alternative push stem of FIGS. 8A through 8C (FIG. 11B).

FIGS. 12A and 12B are comparative, cross sectional perspective views of the of the inlet to the pump chamber, including the disc valve, with a metallic spring (FIG. 12A) and the alternative, all-plastic biasing member of FIGS. 6A through 6C (FIG. 12B).

FIG. 13A is a top plan view and FIG. 13B a cross sectional side plan view of the valve that can be positioned at the inlet and/or outlet of the pump chamber in any of the disclosed embodiments, highlighting the tether(s) or bridging element(s) that keep the flap positioned within the annular sealing element. FIG. 13C is a perspective view of the top of the closure cap in isolation, highlighting the inlet bore and the air return vents/apertures positioned radially around an axial cylinder defining the valve well proximate the inlet bore.

FIG. 14 provides a comparison of traits and characteristics for the prior art pump (FIGS. 1A through 1C) against various iterations of the inventive pump, as described by the characteristics in the appended table. All data disclosed in this table should be treated as part of this specification.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

In order to address the aforementioned needs and/or to overcome issues with conventional food and beverage dispensers noted above (e.g., minimizing the dose variation), the inventor realized one solution was to find a way of pushing the pump with greatly reduced force. The theory was if users are used to pushing a pump with higher force (i.e., >40 N), it should be possible to reduce this force by half and thereby incorporate a shorter stroke (more than half the customary length). In this manner, more reliable volumes/doses could be produced because the risk of the pump/actuator not being pushed completely down (i.e., all the way to the base) would be greatly reduced. Thus, one key to the inventive designs was to reduce the friction dramatically by, among other things, using a very light spring.

Conventional large dose pumps are deliberately designed with narrow diameters, so as to fit within the bottle/container neck. By relying on an external engine (i.e., one not disposed within the container or neck), it becomes possible to use wider and shorter pump chamber (and associated components, such as the piston/stem, valves, etc.), thereby reducing axial travel and spring force needed. This means the movement of the engine is now above the bottle neck, with the diameter of the fluid pathways (inlet size, outlet size, and pump chamber diameter) also increased. Normally, when more fluid is dispensed via a shorter stroke, the ETO increases. However, the inventive aspects contemplated herein enable a reduction of ETO by 50% even while reducing the stroke from 54 mm to 13 mm (almost a 4× reduction in axial travel).

The external pump design results in shorter stroke and increased the liquid bore that is 3.4 times larger, while the axial travel or stroke length is reduced by a factor of 3.8. The inventive design also easily achieves less than 5% variation in dose accuracy (depending on bottom valve solution) in comparison to 10% variation for convention designs. One particular example of a conventional pump has a bore ratio of 3.00 (167 mm2/54 mm stroke), whereas the inventive design has a bore ratio of 40.0 (572 mm2/14 mm stroke). Here, the bore ratio is based upon the surface area of the bore at the inlet and outlet, as defined by the minimum diameters or widths thereof (it being understood that the inlet and outlet could have a non-circular shape, provided appropriate adjustments were made to the necessary components).

Another means of expressing the comparative improvement is with respect to the ratio of the diameter of the closure to the length of axial travel, with conventional designs registering such a “travel ratio” of 0.52 (28 mm/54 mm) while the inventive pumps can range between 2.15 (28 mm/13 mm) and 4.75 (38 mm/8 mm).

The inventive design also relies upon a closure that imparts an improved aesthetic. Certain iterations also allow for the use of plastic springs in place of metal springs, thereby making the new design comparatively more sustainable and eco-friendly.

In particular, a “bellows” could be used as a substitute for a metal spring. Examples of such biasing members are disclosed in Patent Cooperation Treaty Publications WO 1994/020221A1 and WO 1996/028257A1, as well as U.S. Pat. Nos. 5,673,824; 5,819,990; and 5,924,603. Other proposed solutions for non-metallic springs can be found in Japanese Patent Publication 2005024100A; Patent Cooperation Treaty Publications WO2001/087494A1, WO2018/126397A1, and WO2020/156935A1; French Patent FR2969241B1; Korean Patent KR102174715B1; United States Patent Publications 2009/0102106A1, 2012/0325861A1, 2015/0090741A1, 2017/0157631A1, 2019/0368567A1, and 2020/0032870; and U.S. Pat. Nos. 5,819,990; 6,068,250; 6,113,082; 6,223,954; 6,983,924; 10,741,740; and 10,773,269. All of these disclosures are incorporated by reference.

Irrespective of the biasing member (all-plastic bellows, other plastic springs, or conventional metallic coiled springs), another notable feature in comparison to conventional food pumps is that the central portion of the biasing member need not be fitted around the piston or stem along its entire length. That is, whereas the prior art example provided a spring on the outer facing of the reciprocating stem, the inventive design merely captures the top and bottom portions. This provides for several advantages: 1) it simplifies the assembly of the pump by eliminating the need to coaxially and completely seat the biasing member over the elongated stem and 2) because the spring is positioned within the fluid pathway, it encourages the use of all-plastic members, which reduces the chances of metallic corrosion and promotes the use of a fully-recyclable design. Also, the shorter overall axial travel necessarily means that a shorter spring can be used (which was previously a detriment to the use of plastic springs in large volume dispensers-previously, the plastic springs could not easily accommodate the long axial travel lengths required by these large dose dispensers).

Further, the inventive aspects herein are easily adapted to the large-sized container necks used in the food and beverage industry, including but not limited to 28 mm and 38 mm. In a 38 mm sized closure, the dose volume could be as large as 8 mL, while only requiring 8 mm of axial travel. Still other arrangements are possible.

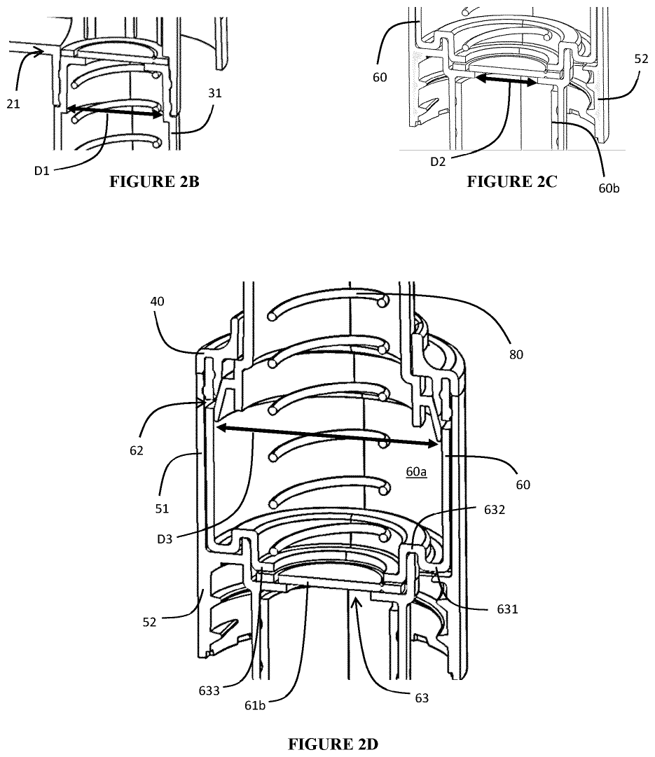

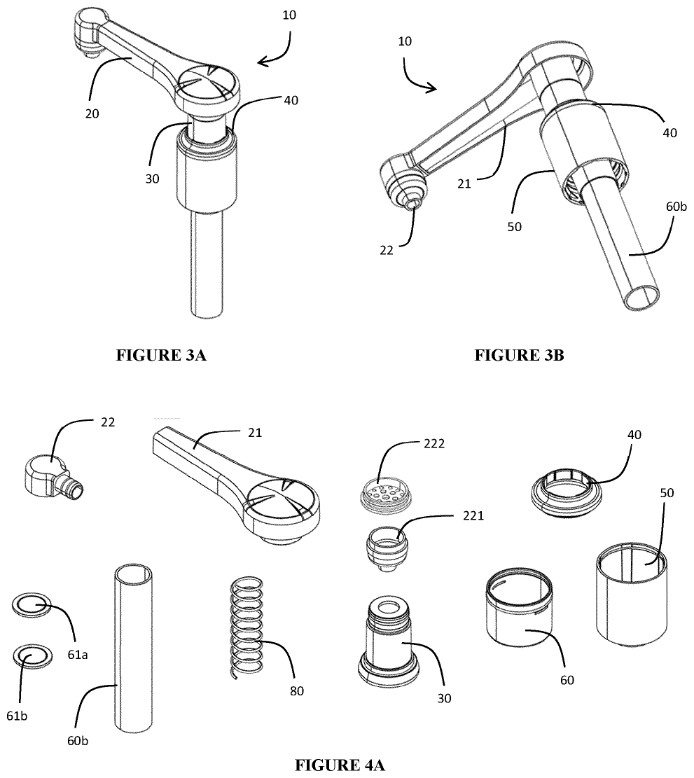

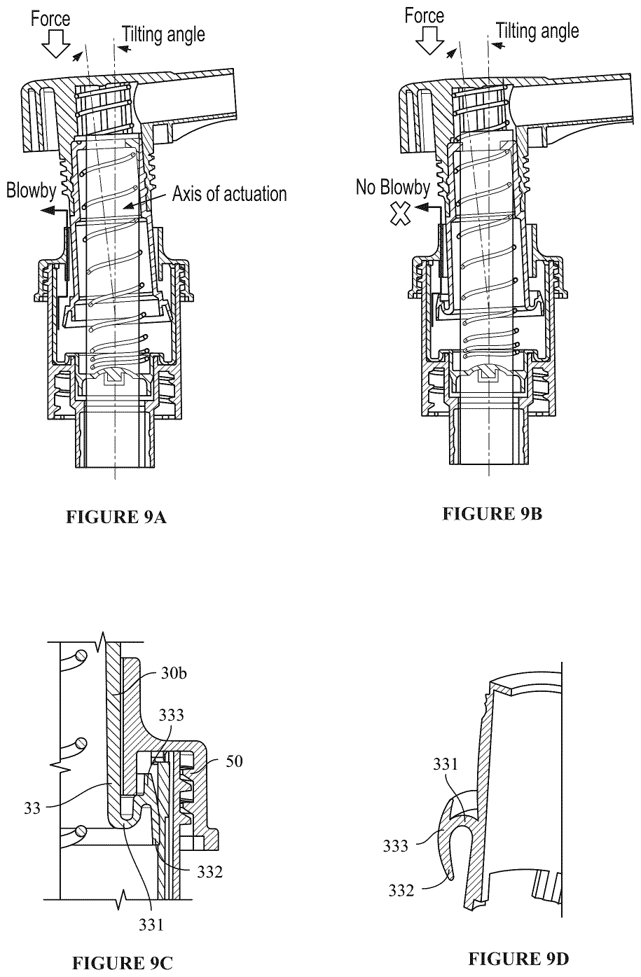

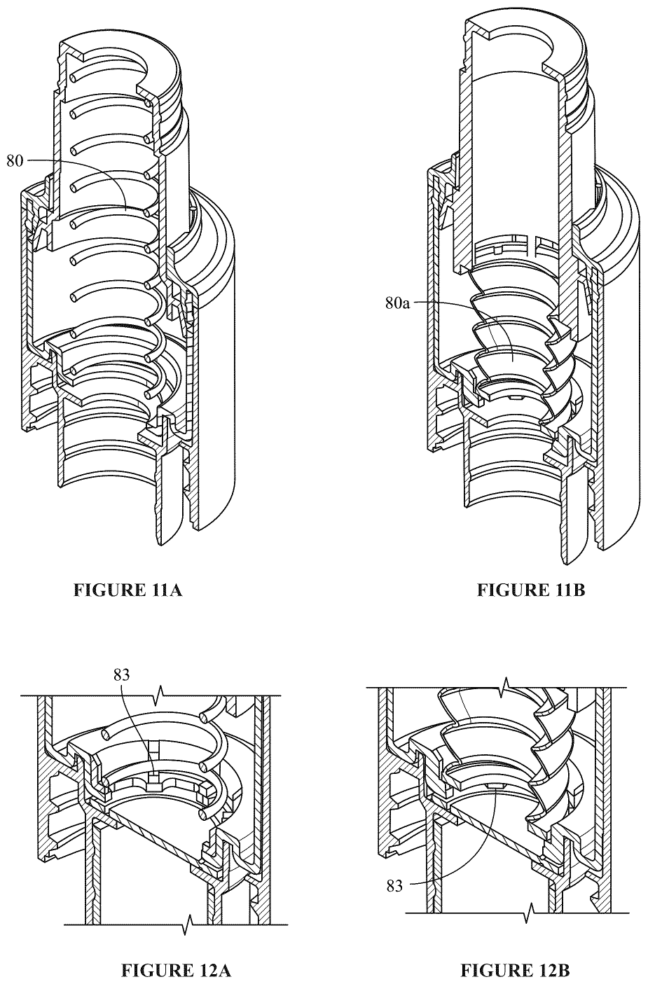

Turning to the drawings, FIGS. 2A through 13B illustrate various aspects and individual components. These will all be described in greater detail, but a few salient points will first be noted.

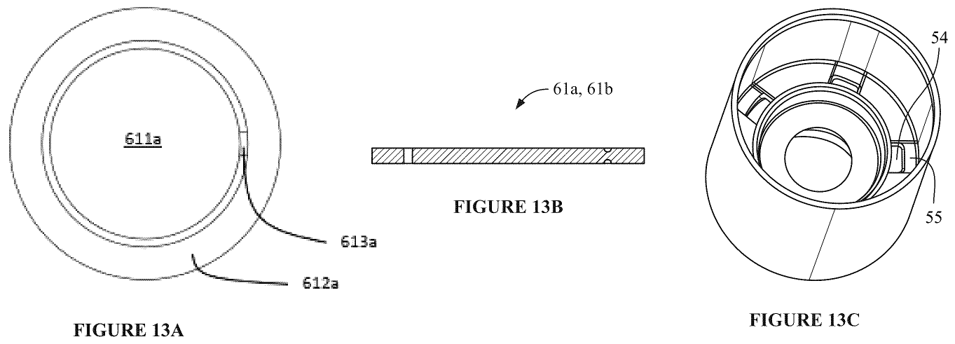

The pump generally consists of an actuator, a piston or push stem coupled to the actuator head, a biasing member, and a closure element. The closure element may be formed integrally or as a H-profile cap with a sleeve received in the upper portion of the cap. A coupling or snap-top collar/cover is fitted on the upper portion after the piston stem has been placed therein. Tethered flap valves (like the ones shown in FIGS. 13A and 13B) are captured at the inlet (at the interface of the cap and sleeve) and outlet (at the interface of the actuator head and the piston stem) of the pump chamber defined by the sleeve/closure element. A dip tube can be coupled to a fitment on the lower side of the cap so as to draw fluid from the lower reaches of a container.

Bead-and-groove, slot-and-tab, or other coupling formations are provided at the interfaces of the actuator head and piston stem, within the closure elements individual components (and more specifically, at or near the top edges of the cap and the cover/collar), and anywhere else where a secure and possibly sealed fit is desired.

The sleeve conforms the contours of the cap but includes one or more vent apertures. These apertures are positioned within the upper portion of the cap at a level where wipers on the piston stem may seal the apertures (when the pump is fully extended) or expose/open the apertures. When open, return air may flow down through the piston stem and collar/cover, through the apertures, along the interface between the sleeve and an upright skirt defining the upper portion of the H-style cap, through vent apertures formed on the radial flange of the cap, and into the container.

The H-style cap has a general cross sectional shape approximating the letter H. The aforementioned top skirt is joined to a radial flange which defines the inlet bore and incorporates return air vents. A lower skirt extends below the flange, with its inner facing including threads or other features so that the cap can be attached to a container neck. An axial flange extending from the radial flange near the inlet bore defines a valve well. Channels or grooves may be formed on the collar/cap and the upper skirt to define the air pathway.

The valves comprise a circular blocking flap coaxially disposed within an annular sealing ring. The ring and flap are connected by one or more thinned tethers, which allow the flap to be temporarily displaced when exposed to suction created by the reciprocating action of the piston stem (and actuator) relative to the cap (and closuring element). These valves retain fluid in the pump chamber and prevent unwanted flowback, while also serving to protect the fluid from the ambient environment.

The piston stem includes a hollow bore of similar or greater diameter than the inlet bore. Similarly, the inner diameter of the pump chamber, whether defined by the inner facings of the sleeve or by the upper skirt, has a greater diameter than that of the piston stem. At its lower end, the piston stem includes wipers that seal to the inner facing of the pump chamber, thereby enabling suction to be created as the actuator urges the piston stem up and down. At its top end, the piston stem includes an outlet bore, preferably of similar dimensions to the inlet bore and sealed by a similar tethered flap valve (which is captured between the actuator head and the piston stem).

The inlet bore is configured to receive and support the lower extremity of a biasing member. The upper extremity is designed to couple or at least be retained by features on or near the hollow bore of the piston stem. These features may be interference fit, or they can simply be ribs or protrusions that cooperate with similar ribs or protrusions on the spring to restrain the spring and keep it positioned properly.

In operation, fluid is drawn up the hollow dip tube, past the inlet tether flap and into the pump chamber. Notably, because the pump chamber is not positioned within the container neck, its diameter is significantly larger than the dip tube. In turn, this increased diameter allows the pump chamber to accommodate larger volumes while retaining a shorter axial height in comparison to pump chambers on conventional food and beverage pumps.

The actuator head defines the final stages of the fluid pathway, with the outlet valve again providing sealing at the top edge of the pump chamber. The actuator may include a nozzle tip (like those shown in FIGS. 4A through 4C). The tip may provide desired flow patterns to the fluids being dispensed and/or it may include an additional valve or other structure to prevent dripping and leakage from the pump.

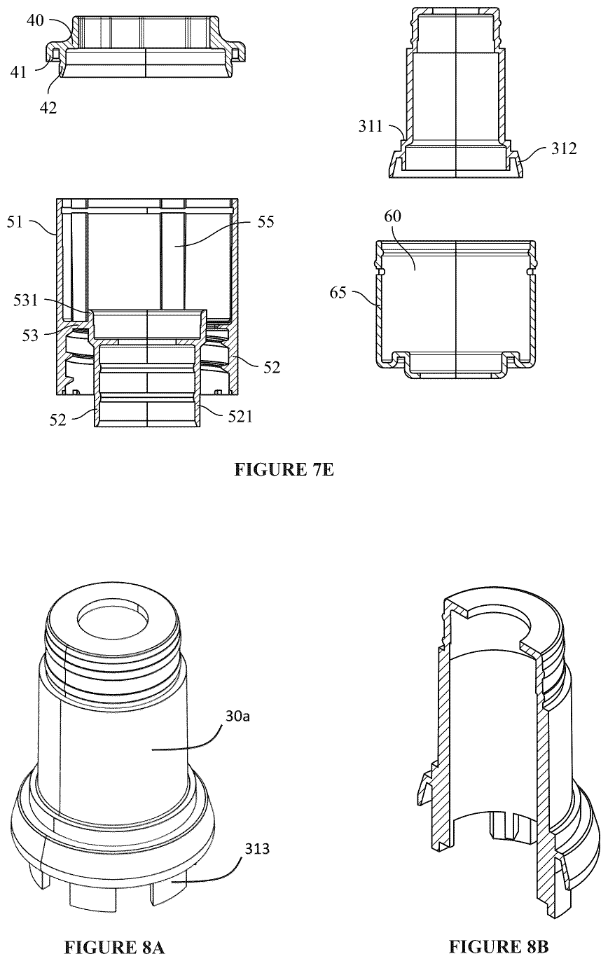

Notably, FIG. 9A illustrates a “blowby” issue that occurs if/when the actuator head is tilted and/or depressed at an angle relative to the normal axis of actuation (i.e., usually, the vertical axis/plane, when the pump is resting on a flat horizontal surface). This results in “blowby actuation” in which the push stem itself travels at an angle. That angle causes the wiper at the end of the stem to temporarily deform and loses its sealing engagement with the inner surface of the sleeve. In turn, a portion of the fluid previously drawn up into the pump chamber (defined by the sleeve and piston) can be forced through this temporary opening as the pump undergoes blowby actuation, causing fluid “leak” out of the pump along the path normally followed by makeup air (i.e., in the interstices between the collar and the mid- or upper-section on the outer surface of the piston stem).

Blowby of this nature is problematic because the expected dose size will be reduced and, equally important, fluid will emanate from and accumulate on the exterior of the pump. When that fluid is perishable and/or prone to evaporate into a sticky residue, instances of blowby can be fatal to the utility of the pump itself (owing to inconsistent dosing, fluid loss, and potential soiling and/or spoilage of the fluid on the exterior surfaces of the pump).

In some instances, blowby can be addressed through judicious selection of materials. That is, by relying on sufficiently rigid and inflexible materials and wall thicknesses, the piston stem/wiper can be designed to not flex or deform. However, such design choices may not always be feasible to the extent thicker walls increase costs and rigid materials may not be preferred owing to manufacturing processes, sustainability, and/or cost considerations.

In such instances, the features of the piston stem can be altered as shown in FIGS. 9B and 9C. Rather than providing a straight angled wiper that comes into contact with the sleeve, the wiper itself may be curved or rounded. Equally important, this “flexible spherical” wiper is attached to the main cylinder of the piston stem by a U-shaped connector. The U-shaped connector allows for the wiper element carried on its end to flex without necessarily losing contact with the inner surface of the sleeve. Thus, when a blowby actuation event occurs, the wiper flexes along the impacted region but does not lose its sealing contact with the sleeve. Thus, all of the dispensed fluid is forced through the inner channel defined by the piston and out of the nozzle, without any unwanted loss or leakage.

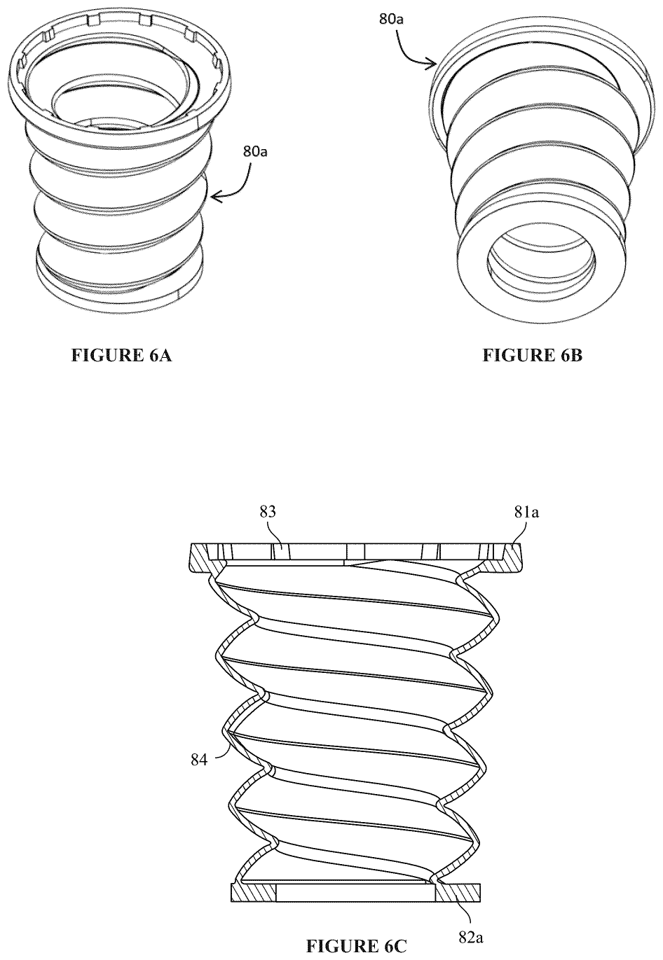

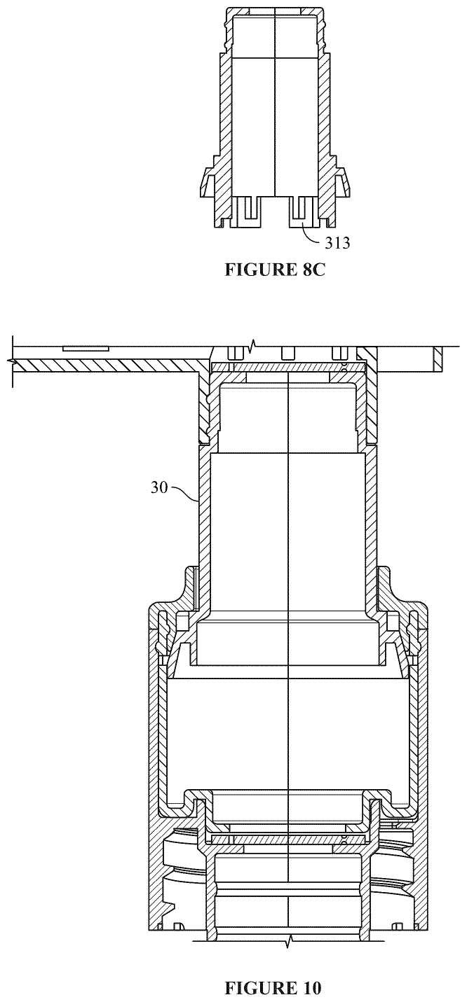

In this alternative arrangement, the elevation/location of the vent hole within the sleeve may be moved upward in comparison to its positioning in the embodiments of FIGS. 7C and 10. Insoafar as this vent allows for equilibrating air flows during and after actuation, its precise elevation is somewhat immaterial so long the blowby conditions noted above are avoided.

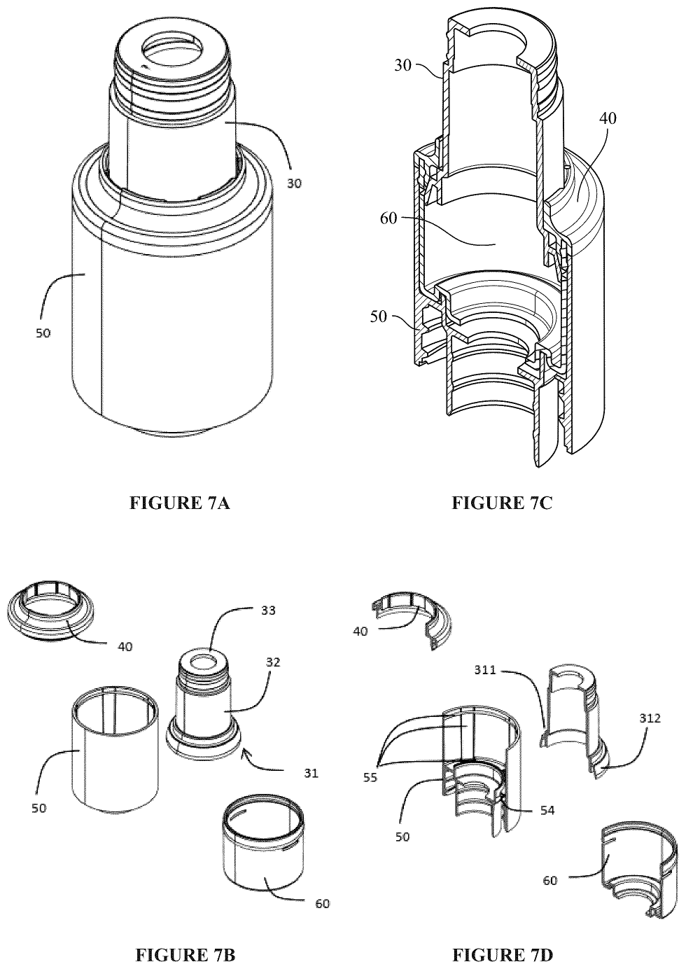

Notably, this flexible spherical wiper can also be employed with the all-plastic biasing member design contemplated in FIGS. 8A through 8C. Here, the curved wiper might be attached by an inverted-U or angling C-shaped radial as show in FIG. 9D, thereby accommodating the flexing action of the wiper. The crenellations at the lower extremities of the piston stem (which allow for fluid to flow to escape from the bellows and flow outside of it in the pump chamber) are retained, so long as they are located radially inward from the radial range of flexing expected for the wiper.

In all embodiments of the flexible spherical wiper, a stopper surface is provided, usually on the radial flange or arm that connects the wiper to the main body of the piston stem (either at its lower-most end, as seen in FIG. 9C, or at its comparative midsection, as seen in FIG. 9D). This stopper defines the upper most range of motion for the actuator head (i.e., its “resting position”), and it may be: a horizontal flange disposed on an inner facing of the wiper or the inverted U- or C-shape that imparts flexibility to the wiper itself. This stopper will come into contact with a formation on the sleeve or the closure itself.

A corresponding stopping surface, also forming part of the flexible spherical wiper structure also defines the lower most range of motion. In this instance, it may be the lower edge of the wiper, a skirt or crenelated extension positioned concentrically within the wiper (and offset radially inward enough to allow for the expected flexing action), or a combination of the two. Usually, this stopper will contact the sleeve or the closure.

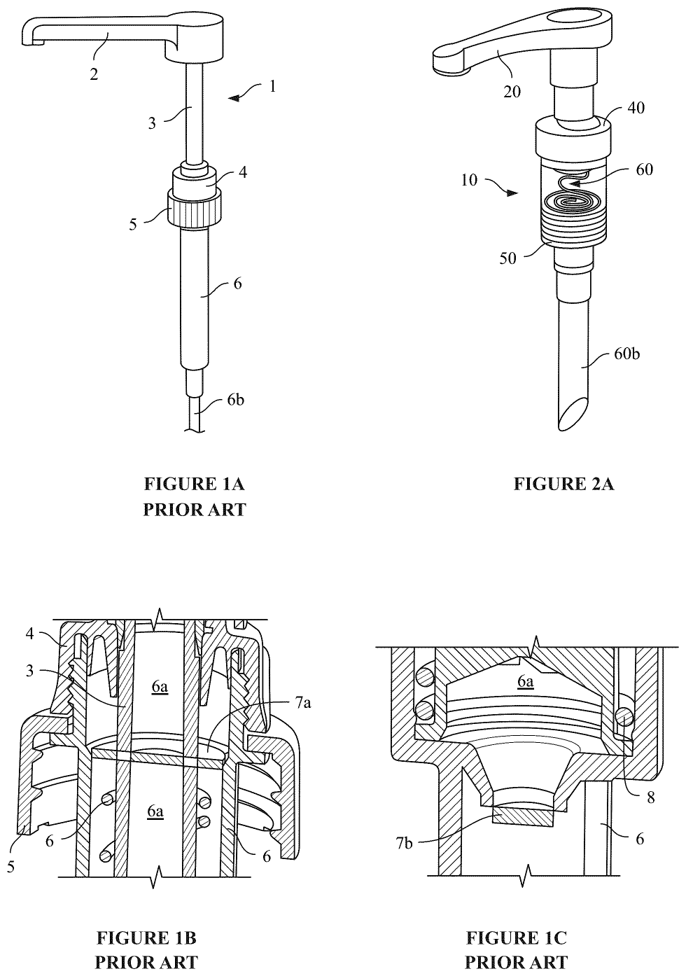

Turning now to the drawings, FIGS. 1A through 1C show comparative views of the type of prior art dispenser that the invention is expected to improve upon and replace. Prior art pump 1 generally includes a plunger or actuator head 2 that is connected to and moves in concert with a stem 3 which, itself, drives the movement of a piston (not shown) that varies volume and creates suction within the pumping chamber 6a. A spring 8 urges the head 2 up and away from a collar 4 and closure cap 5. Pump housing 6 is coupled to the collar 4 and/or closure 5, and its interior defines pump chamber 6a. Dip tube 6b may be attached to the inlet of the housing 6.

Notably, the vast majority, if not the entirety, of that pump chamber 6a is positioned coaxially within the diameter of closure 5. This arrangement requires that the maximum possible diameter or area 7a for fluid passing through the pump chamber 6a toward the outlet must be significantly smaller than the inner diameter of the closure 5, so as to receive the housing 6 and the lower portions of the stem 3. Because the dosing volume of the pump 1 is dictated by the volume of the pump chamber 6a, it becomes necessary to extend the axial length of the housing 6 and pump chamber 6a in order to increase dosing size. In turn, the actuation stroke needed to initiate pumping also becomes larger.

Additionally, conventional pumps of the prior art tend to have an even smaller maximum possible diameter or area 7b at their inlet because the spring 8 must be seated coaxially around the inlet. As a result, pumps 1 have a smaller inlet area 7b in comparison to the outlet area 7a. Also, the elongated housing 6 will occupy volume inside of the container that otherwise could have accommodated fluid for dispensing. It should also be noted that valves (not shown, but commonly taking the form of a temporarily displaceable ball) must be positioned at the inlet and outlet in order to allow for proper operation of the pump 1.

Despite these shortcomings, the design of pump 1 has been attractive because of its reliability in consistently dispensing larger doses. Additionally, to the extent spring 8 was made of metal, this prior art design can isolate and prevent the spring from coming into direct contact with the fluid by positioning the spring around the outside of the stem 3, although this further dictates and necessitates a comparatively constricted inlet area 7b (as well as outlet area 7a).

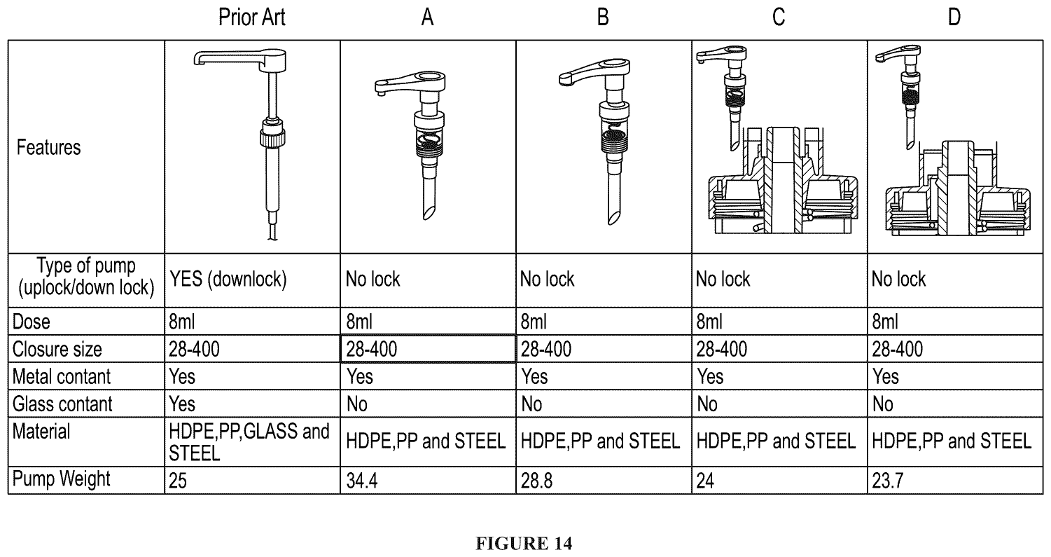

With reference to FIGS. 2A through 14, the pump 10 according to one aspect of the invention includes an reciprocating actuator 20 attached to piston 30. A collar 40 couples to the top edge of the closure 50, thereby securing the pump housing 60 in an upper cup shaped area of the cap 51. The lower section of the cap 52 is configured to attached to a container neck (similar to cap 5), so that the pump chamber 60a is disposed completely outside of the container. Spring 80 is seated with the housing 60 at its lower end and piston 30 and/or proximal end of actuator 20 at its opposing/upper end.

The actuator 20 includes a channel 23 defined by extension 21 and nozzle/outlet 22. Notably, the nozzle 22 may include an open ended or valve controlled opening 221 (with the valve possibly including a duckbill or other similar anti-drip mechanism). Alternatively, nozzle 22 may be closed by a distribution panel 222 having a plurality of apertures arranged to provide a desired dispensing or spraying pattern.

During actuation, the actuator 20 and piston 30 move in unison and in a reciprocating fashion (owing to the biasing force exerted by spring 80) through the pump chamber 60a. Chamber 60a is generally defined by housing 60, which nested within the upper reaches 51 of closure cap 50.

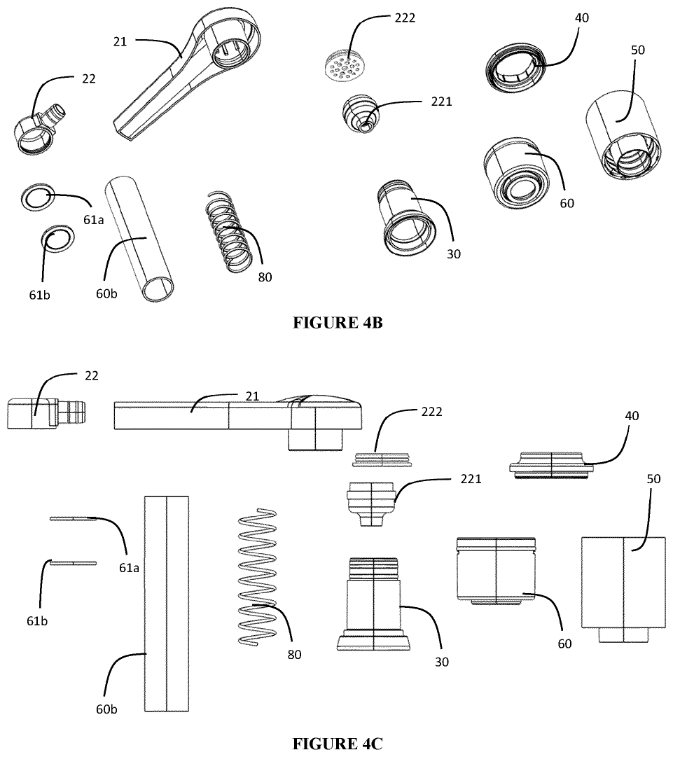

Piston 30 has an enlarged lower end 31 that is configured to conform and seal to an inner surface of the pump chamber 60a. As such, both the pump housing and the piston have cooperating, and preferably circular, transverse shapes (i.e., the transverse plane running within horizontal plane of FIG. 5A). The middle portion 32 is hollow, while the upper end 33 is configured to couple to the actuator 20. All three portions 31, 32, 33 define a flow path that connects to channel 23, so as to allow dispensing of fluid through the outlet 22.

Lower portion 31 includes a radial flange 311 having a sealing wiper 312. This wiper seals to the inner facing of the housing wall to alter the volume of the chamber 60a and create suction as the actuator 20 is urged upward. Notably, the outer-most edge (usually at its distal end) of the wiper 312 has substantially the same diameter D3 as the inner facings of the housing 60. Also, as seen in FIGS. 2B through 2D, diameter D3 approaches the inner diameter of the container neck, thereby allowing the pump chamber 60a to have a comparatively smaller axial height (in view of FIGS. 1A through 1C), thereby shortening the reciprocating stroke without surrendering any of the other benefits of the pump 10. As seen in some of the figures, the cap 50 (or its upper portions 51) and the housing 60 could be made from a transparent or translucent polymeric material to allow a user to visually confirm fluid flow through the pump 10. Separately, as noted above, cap 50 has an H-shape, with optional anti-back-off features (e.g., ratchet teeth, indents, etc.) and coupling or attachment features on the inner facing of the lower portion 52. The upper portion 51 is configured to receive and retain the pump body 60 by way of contours and/or features imparted on the radial ledge 53 (which effectively forms the horizontal connecting portion of the H-shape). Ledge 53 includes an air flow aperture 54, and the interfacing surfaces of the closure 50 and housing 60 can be offset or imparted with features 55 such as radial channels, axial grooves, circumferential arcuate indents, and/or other features to allow for make-up air to be distributed throughout the pump 10, so as to avoid unwanted pressure differentials between the interior of the container (to which the pump is attached) and the ambient environment.

That body 60 includes one or a plurality of vent holes 62 at its top, open end, imparting a cup shape but with a central aperture sized to receive flap or disc valve 61b. The valve 61b can be seated proximate the inlet aperture 63 in a well 633 defined by a raised annular ridge 632 that couples to the side wall by radial flange 631. The inner facing of the cylindrical walls 65 will be smooth so as to maintain a seal with the piston 30.

As noted above, radial ledge 53 include an extension 531 to couple to the body 60. On an opposing/lower facing of ledge 53, a tubular extension 521 protrudes coaxially downward, including ribs or grooves, to couple to a dip tube 60b.

The housing is sealed by an annular collar 40. The aperture in the collar 40 is sized to receive the middle portion 32 of piston while retaining its lower end 31 inside the pump chamber 60a. The collar 40 includes an outer skirt 41 offset from a plug seal extension 42, with these elements spaced apart to snap-fit to the top edge of the housing 60, thereby creating an air-tight seal.

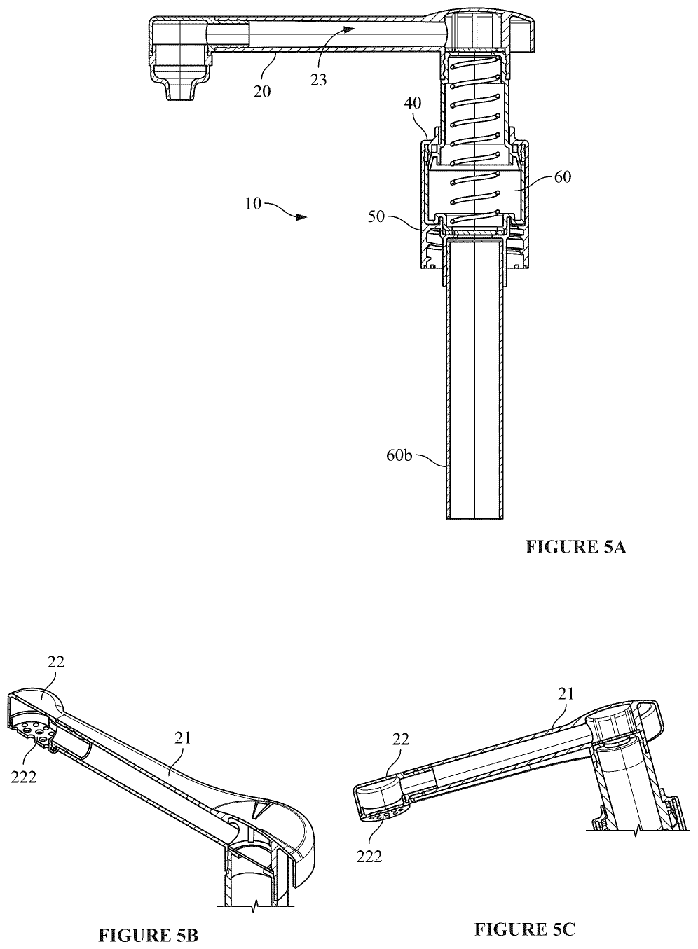

FIGS. 6A through 6C show an alternative biasing member 80a to replace spring 80. Member 80a is made from all plastic, preferably the same or a compatible polymer to the material used to make the remaining components of the pump 10 (e.g., polypropylene and/or polyethylene). The member 80a can be configured to form part of the fluid flow path (i.e., it seals the connect from the inlet 63 to the outlet valve 61a). Alternatively, the member 80a can simply provide biasing force, with fluid flowing around and/or through the cone/sidewalls.

Member 80a is formed as a resilient, spiraling cone in which the sidewalls compress and expand to provide the biasing force to extend the actuator 20 away from the cap 50. Its top end 81a may be larger in comparison to its bottom end 82a, and both may be provided with a reinforced flange. When present, the reinforced flange can include radial and/or axial projections 83 to facilitate coupling the biasing member to adjacent components. Projections 83 may also provide spacing for fluid flow in some aspects, and these projections could be employed at other interfaces along the fluid flow paths of the pump 10, including proximate to the inlet on the housing 60 and/or closure 50 (i.e., the liquid flow path running through the diptube, into the pump chamber, and out the actuator and/or the “make up air” flow path that passes between the collar/closure and the piston and through the vent apertures of the pump housing).

Other all-plastic biasing member designs include both the inventions and prior art solutions described in International Patent Publications WO2022/038199A1 and WO2022/038194A1, both of which are incorporated by reference. Still other solutions and designs are apparent to persons of skill in this field, who will appreciate the shortened axial travel and unique configuration of the piston and pump chamber are more pertinent to the technical solutions (in comparison to the precise form of the spring/biasing member).

FIGS. 8A through 8C show an alternative arrangement for the piston, denoted here as 30a. Piston 30a includes the same features as piston 30, along with spaced apart, downward extensions 313. These extensions 313 impart a “crenelated” appearance that will allow fluid flow therethrough.

FIGS. 9A through 9D show yet another alternative for the piston, denoted here as 30b. Piston 30b includes a reconfigured lower member 33. Here a curving extension 331 forms a U-shaped connector to the wiper 332. An upper extension 333 imparts a C-shape to the wiper 332, and allows for the flexing action described above. This flexing action allows the actuation force to be applied at an angle without creating unwanted blowback conditions noted above and in FIGS. 9A and 9B. Notably, FIG. 9D illustrates an alternative arrangement in which the wiper 332 retains its C-shape, while the curving extension 331 is effectively inverted. FIG. 9D also allows for the use of crenelations/extensions 313.

Still other iterations and features are illustrated in the figures. By way of example rather than limitation, the collar 40 fitted atop the housing 60 may include bead-and-groove features to couple to the top edge of the housing (e.g., between housing 50 and dip tube 60b, etc.). This fitment is equally applicable to other coupled components throughout the pump 10. The valves 61a, 61b can be free-floating discs or, as shown in FIGS. 13A and 13B, annular rings 612a with a hinged extension 613a that allow a central cover 611a to open upward or downward when exposed to the suction or pressurized forces created during actuation.

All components should be made of materials having sufficient flexibility and structural integrity, as well as a chemically inert nature. The materials should also be selected for workability, cost, and weight. Common polymers amenable to injection molding, extrusion, or other common forming processes should have particular utility, although metals, alloys, and other composites may be used in place of or in addition to more conventional container and closure materials.

References to coupling in this disclosure are to be understood as encompassing any of the conventional means used in this field. This may take the form of snap- or force fitting of components, although threaded connections, bead-and-groove, and slot-and-flange assemblies could be employed. Adhesive and fasteners could also be used, although such components must be judiciously selected so as to retain the recyclable nature of the assembly.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. A pump dispenser having an external pump engine including a pump chamber positioned above the radial sealing flange of an H-style closure cap, the dispenser comprising:
a closure element including: (i) a cap having a radial flange defining an inlet bore and at least one air return vent, a lower skirt extending below the radial flange, and an upper skirt, (ii) a valve sealing the inlet bore, and (iii) a sleeve received within the upper skirt, the sleeve having at least one vent aperture and wherein return air pathways are provided between the sleeve and the upper skirt and communicate with the air return vent;
an actuator including an outlet nozzle and a piston stem and wherein the piston stem has hollow tube communicating with the outlet nozzle through an outlet bore and an annular wiper configured to seal to and slide along an inner facing of the sleeve; and
a biasing member positioned between the piston stem and radial flange and urging the actuator away from the closure element.

2. The pump dispenser of claim 1 further comprising a tether valve sealing the outlet bore.

3. The pump dispenser of claim 1 wherein the dispenser has a bore ratio greater than 3, greater than 5, greater than 10, or greater than 20 and wherein the bore ratio is less than 100, less than 80, less than 60, or less than or equal to 40.

4. The pump dispenser of claim 1 wherein the dispenser has a travel ratio greater than 0.60, greater than 0.80, greater than 1.0, greater than 1.5, or greater than or equal to 2.15 and wherein the dispenser has a travel ratio of less than 10.0, less than 5.0, less than or equal to 4.75, less than 3.0 or less than 2.50.

5. The pump dispenser of claim 1 wherein the piston stem and the biasing member are configured so that an axial travel distance during actuation and release of the dispenser is less than 50 mm, less than 40 mm, less than 30 mm, less than 20 mm, or less than or equal to 13 mm.

6. The pump dispenser of claim 1 wherein the piston stem includes a flexible spherical wiper.

7. The pump dispenser of claim 6 wherein the flexible spherical wiper is attached to a lower most end of the piston stem by a flexible U-shaped radial flange.

8. The pump dispenser of claim 6 wherein the flexible spherical wiper is attached to a mid-section portion of the piston stem by a flexible, curved radial flange.

9. The pump dispenser of claim 1 wherein the biasing member is made from an identical polymeric material as used in the closure element and the actuator.
